(19) United States
(12) Patent Application Publication
(10) Pub. No.: US 2013/0262600 A1
(43) Pub. Date: Oct. 3, 2013

(54) IMAGE PROCESSING APPARATUS

(71) Applicant: OKI DATA CORPORATION, Tokyo (JP)

(72) Inventor: Keitaro ISHIDA, Tokyo (JP)

(73) Assignee: OKI DATA CORPORATION, Tokyo (JP)

(21) Appl. No.: 13/796,318

(22) Filed: Mar. 12, 2013

(30) Foreign Application Priority Data
Mar. 29, 2012 (JP) 2012-076617

(51) Int. Cl. H04L 12/58

(52) U.S. Cl. CPC H04L 51/00
USPC 709/206

(57) ABSTRACT

An image processing apparatus includes an image reading unit for reading image data of an original; a communication unit for communicating through a communication network; an image data transmission unit for transmitting the image data to a server specified with an input operation of an operator through the communication unit; and an electric mail transmission unit for transmitting an electric mail to a destination specified with an input operation of the operator through the communication unit. The electric mail transmission unit is configured to transmit the electric mail including storage information of the image data in the server specified with the input operation of the operator and reading permission information of the image data to the destination specified with the input operation of the operator when the image data transmission unit transmits the image data to the server.

### BACKGROUND OF THE INVENTION AND RELATED ART STATEMENT

The present invention relates to an image processing apparatus having a reading device that reads an image of an original.

In general, a conventional image processing apparatus is configured to have a function, in which a reading device thereof reads an image of an original, and a storage unit thereof stores image data of the original thus read. Further, the conventional image processing apparatus is configured to have a function, in which a recording medium records the image data of the original. Further, the conventional image processing apparatus is configured to have a function, in which the image data of the original thus read is transmitted to a computer connected thereto through a network.

Further, the conventional image processing apparatus is configured to have a function, in which the image data of the original read with the reading device is temporarily stored, and the image data is transmitted to an FTP (File Transfer Protocol) server (refer to Patent Reference).
Patent Reference: Japanese Patent Publication No. 2003-198819

In the conventional image processing apparatus disclosed in Patent Reference, however, after the image data read with the reading device is transmitted to the FTP server, when a person, who is to receive the image data, retrieves the image data from the FTP server, it is necessary to obtain and specify information identifying the image data. The information includes a folder name or a file name of the FTP server where the image data is stored, and the like. Accordingly, it is necessary for the operator to perform a cumbersome operation in order to retrieve the image data.

In view of the problems described above, an object of the present invention is to provide an image processing apparatus capable of making it easy for the person, who is to receive the image data, to retrieve the image data from the FTP server.

Further objects and advantages of the invention will be apparent from the following description of the invention.

### SUMMARY OF THE INVENTION

In order to attain the objects described above, according to an aspect of the present invention, an image processing apparatus includes an image reading unit for reading image data of an original; a communication unit for communicating through a communication network; an image data transmission unit for transmitting the image data to a server specified with an input operation of an operator through the communication unit; and an electric mail transmission unit for transmitting an electric mail to a destination specified with an input operation of the operator through the communication unit.

According to the aspect of the present invention, the electric mail transmission unit is configured to transmit the electric mail including storage information of the image data in the server specified with the input operation of the operator and reading permission information of the image data to the destination specified with the input operation of the operator when the image data transmission unit transmits the image data to the server.

In the image processing apparatus of the present invention, it is possible for a person, who is to receive the image data, to easily retrieve the image data from an FTP server.

### BRIEF DESCRIPTION OF THE DRAWINGS

FIG. 1 is a block diagram showing a configuration of an image processing apparatus according to a first embodiment of the present invention;

FIG. 2 is a block diagram showing a configuration of an image encryption and decryption password generation unit of the image processing apparatus according to the first embodiment of the present invention;

FIG. 3 is a block diagram showing a configuration of a communication control unit of the image processing apparatus according to the first embodiment of the present invention;

FIG. 4 is a flow chart showing an operation of the image processing apparatus according to the first embodiment of the present invention;

FIG. 5 is a block diagram showing a configuration of an image processing apparatus according to a second embodiment of the present invention;

FIG. 6 is a block diagram showing a configuration of a communication control unit of the image processing apparatus according to the second embodiment of the present invention; and

FIG. 7 is a flow chart showing an operation of the image processing apparatus according to the second embodiment of the present invention.

### DETAILED DESCRIPTION OF PREFERRED EMBODIMENTS

Hereunder, embodiments of the present invention will be explained with reference to the accompanying drawings. It should be noted that the accompanying drawings are presented just for the explanation purpose, and the present invention is not limited to the accompanying drawings.

### First Embodiment

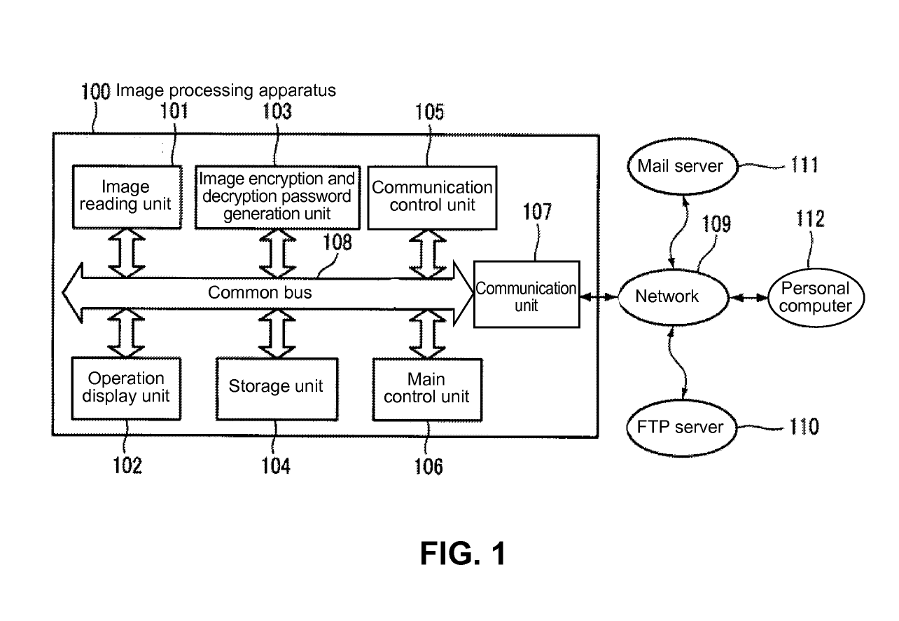

A first embodiment of the present invention will be explained. FIG. 1 is a block diagram showing a configuration of an image processing apparatus 100 according to the first embodiment of the present invention. In the first embodiment, the image processing apparatus 100 is a reading apparatus such as a scanner and the like.

As shown in FIG. 1, the image processing apparatus 100 includes an image reading unit 101 for inputting image data of an original read with a reading sensor thereof; an operation display unit 102 formed of an input unit for receiving an input operation of an operator and a display unit such as a display and the like; an image encryption and decryption password generation unit 103 for encrypting the image data and generating a decryption password; and a storage unit 104 for storing the image data thus read and intermediate data generated with each component such as encrypted image data.

In the first embodiment, the image processing apparatus 100 further includes a communication control unit 105 for controlling transmission and reception communication with respect to an FTP (File Transfer Protocol) server 110, a mail server 111 or a personal computer 112 as external devices. Further, the image processing apparatus 100 includes a communication unit 107 as a communication device having a function of a communication interface with respect to a network 109 as a communication network; a main control unit 106 for controlling each component to control an operation of the image processing apparatus as a whole; and a common bus 108 for connecting each component.

In the first embodiment, the image reading unit 101 is formed of an image reading device for reading the image data of the original. More specifically, the image reading unit 101 is configured to input the image data of the original read by a reading sensor (not shown). It is noted that the image reading unit 101 may be provided with the image sensor therein, so that the image data of the original is input into the image reading unit 101.

In the first embodiment, the operation display unit 102 has a function of displaying an operational method or operation information relative to the operator, who operates the image processing apparatus 100, on a display device such as a liquid crystal display and the like. Further, the operation display unit 102 has a function of receiving an input operation of the operator through an input device such as specifying a name of the FTP server as a transmission destination of the image data; specifying a storage location (a storage folder name) of the FTP server to which the image data is stored and a file name of the image data; and registering and selecting the transmission destination address of an electric mail.

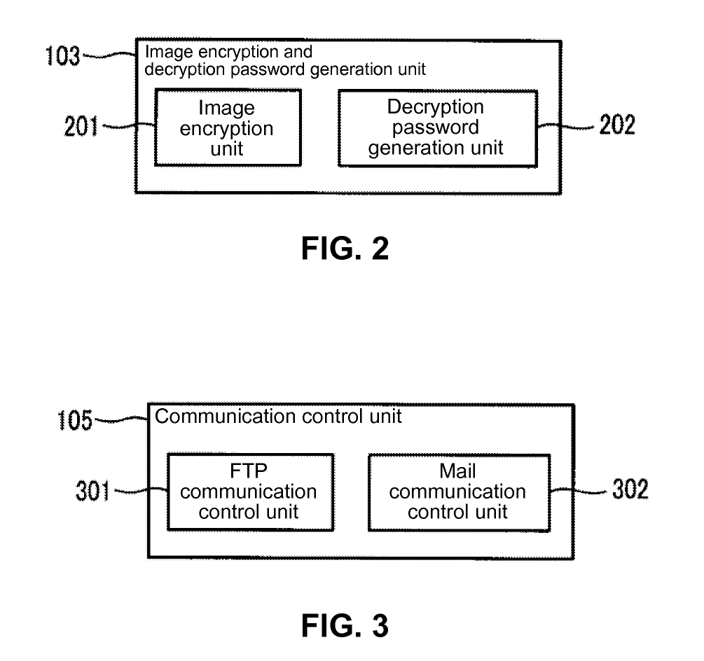

FIG. 2 is a block diagram showing a configuration of the image encryption and decryption password generation unit 103 of the image processing apparatus 100 according to the first embodiment of the present invention. As shown in FIG. 2, the image encryption and decryption password generation unit 103 includes an image encryption unit 201 and a decryption password generation unit 202.

In the first embodiment, the image encryption unit 201 is an encryption device for encrypting the image data read by the image reading unit 101. More specifically, the image encryption unit 201 has a function of retrieving the image data stored in the storage unit 104, and encrypting the image data according to a random number generated therein. It is noted that an encryption algorism of the image encryption unit 201 is not limited to a specific one.

In the first embodiment, the decryption password generation unit 202 is a decryption password generation device for generating a password (referred to as a decryption password hereinafter) for decrypting the image data thus encrypted as reading permission information. More specifically, the decryption password generation unit 202 has a function of generating the password for decrypting the image data encrypted with the image encryption unit 201 according to a random number generated with the image encryption unit 201. The password is used for decrypting the image data thus encrypted, and corresponds to the reading permission information of the image data.

FIG. 3 is a block diagram showing a configuration of the communication control unit 105 of the image processing apparatus 100 according to the first embodiment of the present invention. As shown in FIG. 3, the communication control unit 105 includes an FTP communication control unit 301 and a mail communication control unit 302.

In the first embodiment, the FTP communication control unit 301 is an image data transmission device for transmitting the image data to a server specified through the input operation of the operator through the communication unit 107 as the communication device. More specifically, the FTP communication control unit 301 has a function of transmitting the image data to the FTP server 110 according to file transfer protocol (referred to as FTP transmission hereinafter) according to the FTP server name as the storage destination of the image data received through the operation display unit 102, the storage location of the FTP server (the storage folder name), and the file name of the image data thus specified.

In the first embodiment, the mail communication control unit 302 is an electric mail transmission device for transmitting an electric mail to the transmission destination specified through the input operation of the operator through the communication unit 107 as the communication device. More specifically, the mail communication control unit 302 has a function of transmitting the electric mail to a destination address of the electric mail received with the operation display unit 102 through the mail server 111. Further, the mail communication control unit 302 has a function of generating the electric mail including the FTP server name as the storage destination of the image data received through the operation display unit 102, the storage location of the FTP server (the storage folder name), the file name of the image data, and the password for decrypting the image data generated with the image encryption unit 201.

In the first embodiment, the electric mail includes the FTP server name as the storage destination of the image data received through the operation display unit 102, the storage location of the FTP server (the storage folder name), and the file name of the image data as links. Accordingly, when the links are clicked, it is possible to access to the image data stored in the FTP server 110. In the image processing apparatus 100 with the configuration as described above, the main control unit 106 is configured to control an entire operation of the image processing apparatus 100 according to a control program (software) stored in the storage unit 104.

In the first embodiment, the network 109 connected to the image processing apparatus 100 is connected to the FTP server 110, the mail server 111, and the personal computer 112 for receiving the image data. Accordingly, the image processing apparatus 100 is capable of communicating with the FTP server 110, the mail server 111, and the personal computer 112 through the network 109.

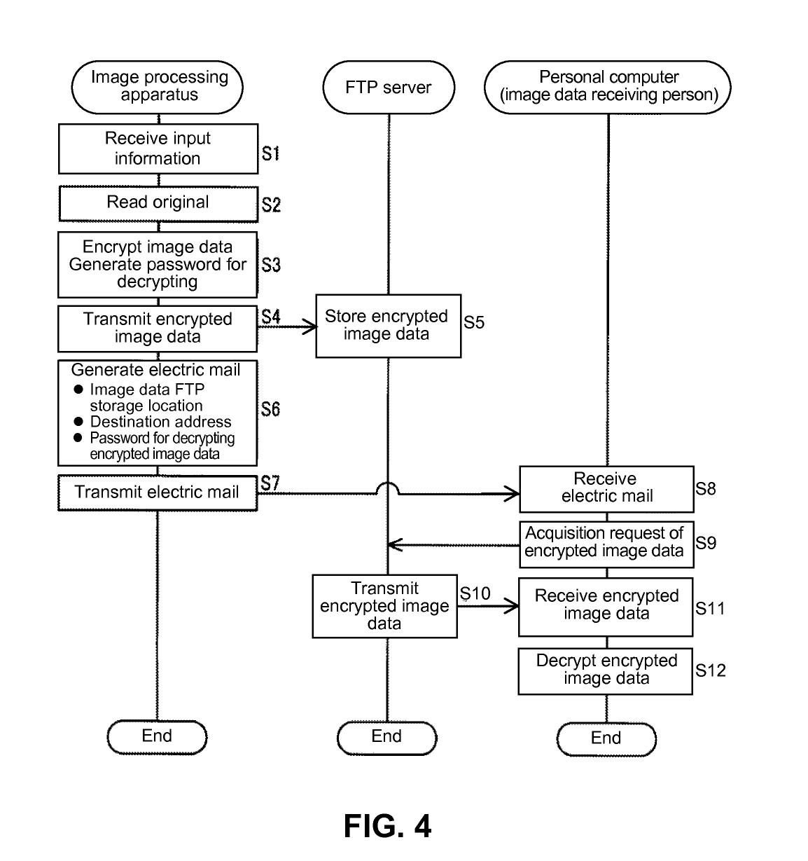

An operation of the image processing apparatus 100 will be explained next. More specifically, an operation of processing the image data performed by the image processing apparatus 100 will be explained with reference to steps represented with S in a flow chart shown in FIG. 4 as well as FIGS. 1 to 3. FIG. 4 is the flow chart showing the operation of the image processing apparatus 100 according to the first embodiment of the present invention.

In step S1, the operation display unit 102 of the image processing apparatus 100 receives input information through the input operation of the operator. The input information includes ID information identifying the operator who operates the image processing apparatus 100, the FTP server name as the storage destination of the image data, the storage location (the folder name) and the file name of the FTP server, and the destination address (to) of the electric mail. If necessary, the input information may include the electric mail address that the operator uses as an originator address (from).

In step S2, the image reading unit 101 reads the original to input the image data of the original thus read. Then, the image reading unit 101 stores the image data in the storage unit 104.

In step S3, after the image reading unit 101 stores the image data in the storage unit 104, the image encryption unit 201 of the image encryption and decryption password generation unit 103 encrypts the image data stored in the storage unit 104, so that the image encryption unit 201 rewrites the image data as the encrypted image data. At the same time, the decryption password generation unit 202 generates the password for decrypting the encrypted image data.

In step S4, after the image encryption and decryption password generation unit 103 encrypts the image data and generates the decryption password, the FTP communication control unit 301 of the communication control unit 105 transmits the encrypted image data stored in the storage unit 104 to the FTP server 110 corresponding to the FTP server name input in step S1 through the communication unit 107.

In step S5, the FTP server 110 receives the encrypted image data transmitted from the image processing apparatus 100, so that the FTP server 110 stores the encrypted image data in a storage unit thereof according to the information of the storage location (the folder name) and the file name of the FTP server input in step S1.

In step S6, the mail communication control unit 302 of the communication control unit 105 of the image processing apparatus 100 generates the electric mail including the FTP server name as the storage destination of the image data, the storage location (the folder name) and the file name of the FTP server, the destination address (to) of the electric mail input in step S1, and the password for decrypting the encrypted image data.

In this case, when the operator inputs own electric mail address (or a specific electric mail address) into the originator address (from) of the electric mail, the electric mail is generated with the input address as the originator address. When the operator does not input the originator address (from) of the electric mail, the electric mail is generated with an apparatus specific electric mail address defined in the image processing apparatus 100 as the originator address.

In step S7, the mail communication control unit 302 of the communication control unit 105 transmits the electric mail thus generated to the personal computer 112 of a person, who is to receive the image data, as the destination address (to) of the electric mail thus input through the mail server 111.

In is noted that the mail communication control unit 302 may be configured to generate two electric mails; one electric mail including the FTP server name as the storage destination of the image data, the storage location (the folder name) and the file name of the FTP server, and the destination address (to) of the electric mail input in step S1; and another electric mail including the password for decrypting the encrypted image data. Then, the mail communication control unit 302 transmits the two electric mails thus generated to the personal computer 112 of the person, who is to receive the image data, as the destination address (to) of the electric mail thus input through the mail server 111. When the mail communication control unit 302 transmits the two electric mails separately, it is possible to prevent a third party from simultaneously knowing the storage location and the file name of the encrypted image data and the password for decryption.

As described above, when the FTP communication control unit 301 as the image data communication device transmits the image data to the FTP server 110, the mail communication control unit 302 as the electric mail transmission device is configured to transmit the electric mail including the storage information (the information including the FTP server name, the storage location (the folder name) and the file name of the FTP server) of the image data in the FTP server 110 specified through the input operation of the operator and the reading permission information (the password for decrypting the encrypted image data) to the destination specified through the input operation of the operator.

In step S8, the personal computer 112 operated by the person, who is to receive the image data, receives the electric mail transmitted from the image processing apparatus 100.

In step S9, the image data receiving person, i.e., the person who is to receive the image data, operates the personal computer 112 to perform the input operation of specifying the FTP server name as the storage destination of the image data, and the storage location (the folder name) and the file name of the FTP server included in the electric mail. For example, the image data receiving person performs a clicking operation on the FTP server name as the storage destination of the image data and the storage location (the folder name) and the file name of the FTP server. As a result, the personal computer 112 transmits an acquisition request of the encrypted image data to the FTP server 110 according to the FTP server name as the storage destination of the image data, and the storage location (the folder name) and the file name of the FTP server thus input.

In step S10, when the FTP server 110 receives the acquisition request of the encrypted image data, the FTP server 110 transmits the encrypted image data stored in the storage unit to the personal computer 112 that the image data receiving person operates in response to the acquisition request of the encrypted image data.

In step S11, the personal computer 112 that the image data receiving person operates receives the encrypted image data from the FTP server 110, so that the personal computer 112 stores the encrypted image data in a storage unit thereof.

In step S12, after the personal computer 112 receives the encrypted image data from the FTP server 110, the personal computer 112 receives an input of the decryption password included in the electric mail received in step S8 through the input operation of the image data receiving person. Accordingly, the personal computer 112 decrypts the encrypted image data stored in the storage unit using the decryption password thus input, so that the personal computer 112 generates the image data. As a result, the image data receiving person obtains the image data.

As described above, in the first embodiment, after the image processing apparatus 100 reads the image data of the original, the image processing apparatus 100 is configured to transmit the electric mail to the image data receiving person. Further, the electric mail includes the FTP server name in which the image data is stored, and the storage location (the folder name) and the file name in the FTP server as storage information of the image data. Further, the electric mail includes the decryption password as the reading permission information. Accordingly, when the image data receiving person tries to obtain the image data from the FTP server 110, the image data receiving person retrieves the FTP server name, and the storage location (the folder name) and the file name of the FTP server using the decryption password included in the electric mail received from the image processing apparatus 100. As a result, the image data receiving person is able to obtain the image data, thereby reducing an operational burden on the image data receiving person.

Further, in the first embodiment, after the operator operates the image processing apparatus 100 to read the original, the operator does not need to generate the electric mail including the FTP server name in which the image data is stored, the storage location (the folder name) and the file name of the FTP server, and the decryption password relative to the image data receiving person, thereby reducing an operational burden on the operator who operates the image processing apparatus 100 to read the original. In particular, when there is a plurality of the image data receiving persons, the operator does not need to transmit the electric mail to each of the image data receiving persons, thereby reducing an operational burden on the operator who operates the image processing apparatus 100 to read the original.

Further, each time when the image processing apparatus 100 reads the original, the image processing apparatus 100 is configured to encrypt the image data to be stored in the FTP server 110 with the random encryption method. Accordingly, even when a plurality of unspecified persons is capable of accessing the FTP server where the image data is stored, it is possible to reduce a risk that the image data may be exposed to a third party.

As described above, in the first embodiment, when the image data receiving person obtains the image data from the FTP server 110, the image data receiving person retrieves the FTP server name, and the storage location (the folder name) and the file name of the FTP server using the decryption password included in the electric mail received from the image processing apparatus 100. As a result, the image data receiving person is able to easily obtain the image data from the FTP server 110.

Further, in the first embodiment, after the operator operates the image processing apparatus 100 to read the original, the operator does not need to generate the electric mail including the FTP server name in which the image data is stored, the storage location (the folder name) and the file name of the FTP server, and the decryption password relative to the image data receiving person, thereby reducing an operational burden on the operator who operates the image processing apparatus 100 to read the original.

Further, each time when the image processing apparatus 100 reads the original, the image processing apparatus 100 is configured to encrypt the image data to be stored in the FTP server 110 with the random encryption method. Accordingly, even when a plurality of unspecified persons is capable of accessing the FTP server where the image data is stored, it is possible to reduce a risk that the image data may be exposed to a third party.

### Second Embodiment

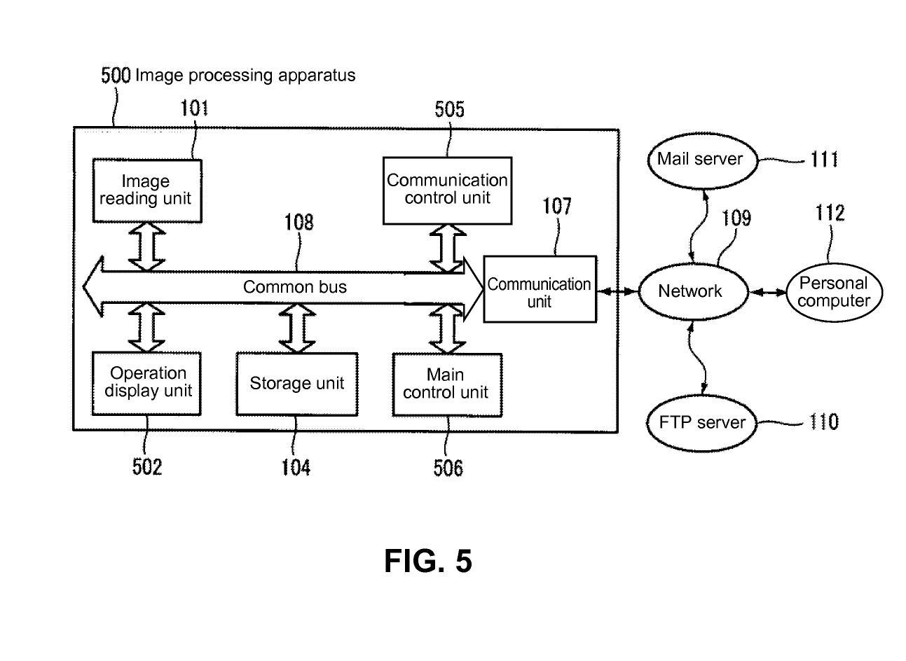

A second embodiment of the present invention will be explained next. FIG. 5 is a block diagram showing a configuration of an image processing apparatus 500 according to the second embodiment of the present invention. In the second embodiment, the image processing apparatus 500 is a reading apparatus such as a scanner and the like.

As shown in FIG. 5, the image processing apparatus 500 includes the image reading unit 101 for inputting image data of an original read with a reading sensor thereof; an operation display unit 502 formed of an input unit for receiving an input operation of an operator and a display unit such as a display and the like; and the storage unit 104 for storing the image data thus read and intermediate data generated with each component such as encrypted image data.

In the second embodiment, the image processing apparatus 500 further includes a communication control unit 505 for controlling transmission and reception communication with respect to the FTP (File Transfer Protocol) server 110, the mail server 111 or the personal computer 112 as external devices. Further, the image processing apparatus 500 includes the communication unit 107 as a communication device having a function of a communication interface with respect to the network 109 as a communication network; a main control unit 506 for controlling each component to control an operation of the image processing apparatus as a whole; and the common bus 108 for connecting each component.

In the second embodiment, the operation display unit 502 has a function of displaying an operation method or operation information relative to an operator who operates the image processing apparatus 500 on a display device such as a liquid crystal display and the like. Further, the operation display unit 502 has a function of receiving an input operation of the operator through an input device such as specifying a name of the FTP server as a transmission destination of the image data; specifying a storage location (a storage folder name) of the FTP server to which the image data is stored and a file name of the image data; specifying a login ID and a password of the FTP server; and registering and selecting the transmission destination address of an electric mail.

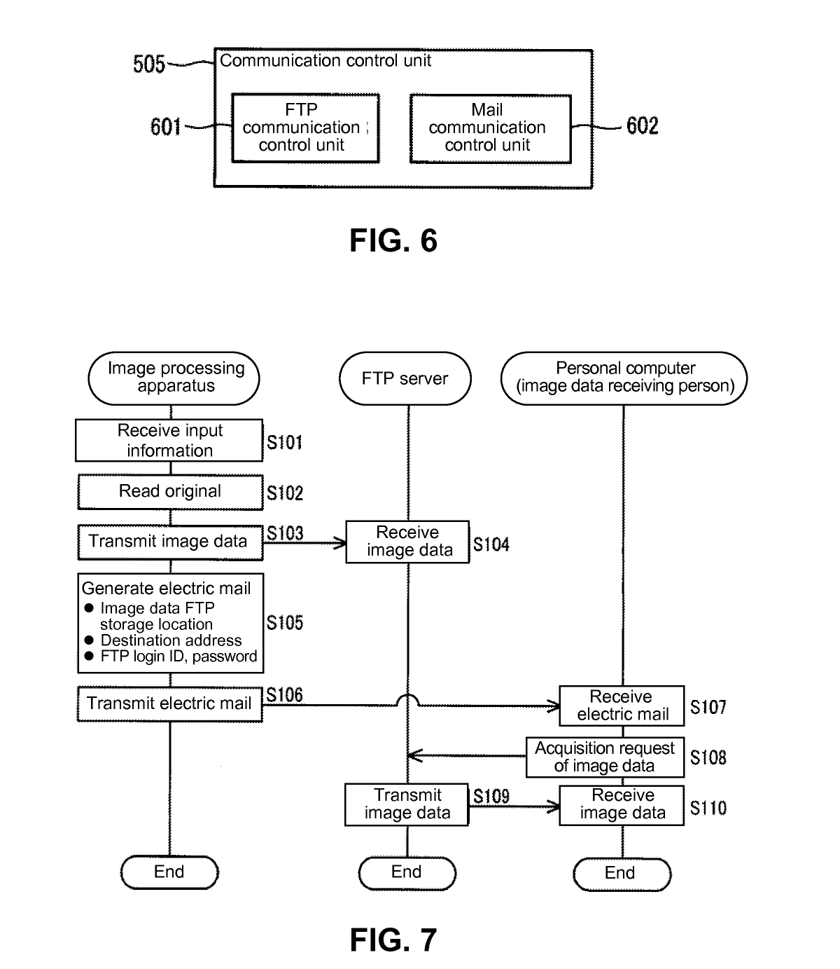

FIG. 6 is a block diagram showing a configuration of the communication control unit 505 of the image processing apparatus 500 according to the second embodiment of the present invention. As shown in FIG. 6, the communication control unit 505 includes an FTP communication control unit 601 and a mail communication control unit 602.

In the second embodiment, the FTP communication control unit 601 is an image data transmission device for transmitting the image data to a server specified through the input operation of the operator through the communication unit 107 as the communication device. More specifically, the FTP communication control unit 601 has a function of transmitting the image data to the FTP server 110 with the FTP transmission according to the FTP server name as the storage destination of the image data received through the operation display unit 502, the storage location of the FTP server (the storage folder name), the login ID and the password of the FTP server, and the file name of the image data thus specified.

In the second embodiment, the mail communication control unit 602 is an electric mail transmission device for transmitting an electric mail to the transmission destination specified through the input operation of the operator through the communication unit 107 as the communication device. More specifically, the mail communication control unit 602 has a function of transmitting the electric mail to a destination address of the electric mail received with the operation display unit 502 through the mail server 111. Further, the mail communication control unit 602 has a function of generating the electric mail including (described with a link) the FTP server name as the storage destination of the image data received through the operation display unit 502, the storage location of the FTP server (the storage folder name), the login ID and the password of the FTP server, and the file name of the image data.

In the image processing apparatus 500 with the configuration as described above, the main control unit 506 is configured to control an entire operation according to a control program (software) stored in the storage unit 104. Further, the network 109 connected to the image processing apparatus 500 is connected to the FTP server 110, the mail server 111, and the personal computer 112 for receiving the image data. Accordingly, the image processing apparatus 500 is capable of communicating with the FTP server 110, the mail server 111, and the personal computer 112 through the network 109.

An operation of the image processing apparatus 500 will be explained next. More specifically, an operation of processing the image data performed by the image processing apparatus 500 will be explained with reference to steps represented with S in a flow chart shown in FIG. 7 as well as FIGS. 5 and 6. FIG. 7 is the flow chart showing the operation of the image processing apparatus 500 according to the second embodiment of the present invention.

In step S101, the operation display unit 502 of the image processing apparatus 500 receives the input information through the input operation of the operator. The input information includes the ID information identifying the operator who operates the image processing apparatus 500, the FTP server name as the storage destination of the image data, the storage location (the folder name) and the file name of the FTP server, the login ID and the password of the FTP server, and the destination address (to) of the electric mail. If necessary, the input information may include the electric mail address that the operator uses as an originator address (from).

In step S102, the image reading unit 101 reads the original to input the image data of the original thus read. Then, the image reading unit 101 stores the image data in the storage unit 104.

In step S103, after the image reading unit 101 stores the image data in the storage unit 104, the FTP communication control unit 601 of the communication control unit 505 transmits the image data stored in the storage unit 104 to the FTP server 110 corresponding to the FTP server name input in step S101 through the communication unit 107.

In step S104, the FTP server 110 receives the image data transmitted from the image processing apparatus 500, so that the FTP server 110 stores the image data in the storage unit thereof according to the information of the storage location (the folder name) and the file name of the FTP server input in step S101. In this case, the image data stored in the storage unit is administered in a state that only an account authenticated by the login ID (user identification information) of the FTP server and the password of the login ID input in step S101 is allowed to access (read) the image data. Accordingly, the login ID of the FTP server and the password of the login ID correspond to the reading permission information of the image data.

In step S105, the mail communication control unit 602 of the communication control unit 505 of the image processing apparatus 500 generates the electric mail including the FTP server name as the storage destination of the image data, the storage location (the folder name) and the file name of the FTP server, the destination address (to) of the electric mail input in step S1, and the login ID and the password of the FTP server.

In this case, when the operator inputs own electric mail address (or a specific electric mail address) into the originator address (from) of the electric mail, the electric mail is generated with the input address as the originator address. When the operator does not input the originator address (from) of the electric mail, the electric mail is generated with an apparatus specific electric mail address defined in the image processing apparatus 500 as the originator address.

In step S106, the mail communication control unit 602 of the communication control unit 505 transmits the electric mail thus generated to the personal computer 112 of the person, who is to receive the image data, as the destination address (to) of the electric mail thus input through the mail server 111.

In is noted that the mail communication control unit 602 may be configured to generate two electric mails; one electric mail including the FTP server name as the storage destination of the image data, the storage location (the folder name) and the file name of the FTP server, the destination address (to) of the electric mail input in step S101, and the login ID of the FTP server; and another electric mail including the password for logging in the FTP server. Then, the mail communication control unit 302 transmits the two electric mails thus generated to the personal computer 112 of the person, who is to receive the image data, as the destination address (to) of the electric mail thus input through the mail server 111. When the mail communication control unit 302 transmits the two electric mails separately, it is possible to prevent a third party from simultaneously knowing the storage location and the file name of the image data and the password for logging in the FTP server.

As described above, when the FTP communication control unit 601 as the image data communication device transmits the image data to the FTP server 110, the mail communication control unit 602 as the electric mail transmission device is configured to transmit the electric mail including the storage information (the information including the FTP server name, the storage location (the folder name) and the file name of the FTP server) of the image data in the FTP server 110 specified through the input operation of the operator and the reading permission information (the login ID and the password of the FTP server) to the destination specified through the input operation of the operator.

In step S107, the personal computer 112 operated by the person, who is to receive the image data, receives the electric mail transmitted from the image processing apparatus 500.

In step S108, the image data receiving person, i.e., the person who is to receive the image data, operates the personal computer 112 to perform the input operation of specifying the FTP server name as the storage destination of the image data, the storage location (the folder name) and the file name of the FTP server, and the login ID and the password of the FTP server included in the electric mail. For example, the image data receiving person performs a clicking operation on the FTP server name as the storage destination of the image data, the storage location (the folder name) and the file name of the FTP server, and the login ID and the password of the FTP server. As a result, the personal computer 112 transmits an acquisition request of the image data to the FTP server 110 according to the FTP server name as the storage destination of the image data, the storage location (the folder name) and the file name of the FTP server, and the login ID and the password of the FTP server thus input.

In step S109, when the FTP server 110 receives the acquisition request of the image data, the FTP server 110 transmits the image data stored in the storage unit to the personal computer 112 that the image data receiving person operates in response to the acquisition request of the image data.

In step S110, the personal computer 112 that the image data receiving person operates receives the image data from the FTP server 110, so that the personal computer 112 stores the image data in the storage unit thereof. As a result, the image data receiving person obtains the image data.

As described above, in the second embodiment, after the image processing apparatus 500 reads the image data of the original, the image processing apparatus 500 is configured to transmit the electric mail to the image data receiving person. Further, the electric mail includes the FTP server name in which the image data is stored, and the storage location (the folder name) and the file name in the FTP server as the storage information of the image data. Further, the electric mail includes the login ID and the password of the FTP server as the reading permission information. Accordingly, when the image data receiving person obtains the image data from the FTP server 110, the image data receiving person retrieves the FTP server name, and the storage location (the folder name) and the file name of the FTP server using the login ID and the password of the FTP server included in the electric mail received from the image processing apparatus 500. As a result, the image data receiving person is able to obtain the image data, thereby reducing an operational burden on the image data receiving person.

Further, in the second embodiment, after the operator operates the image processing apparatus 500 to read the original, the operator does not need to generate the electric mail including the FTP server name in which the image data is stored, the storage location (the folder name) and the file name of the FTP server, and the login ID and the password of the FTP server relative to the image data receiving person, thereby reducing an operational burden on the operator who operates the image processing apparatus 500 to read the original. In particular, when there is a plurality of the image data receiving persons, the operator does not need to transmit the electric mail to each of the image data receiving persons, thereby reducing an operational burden on the operator who operates the image processing apparatus 500 to read the original.

Further, the image data stored in the FTP server is administered in the state that only an account authenticated by the login ID and the password of the FTP server thus specified is allowed to access the image data. Accordingly, even when a plurality of unspecified persons is capable of accessing the FTP server where the image data is stored, it is possible to reduce a risk that the image data may be exposed to a third party.

As described above, in the second embodiment, when the image data receiving person obtains the image data from the FTP server 110, the image data receiving person retrieves the FTP server name, and the storage location (the folder name) and the file name in the FTP server using the login ID and the password of the FTP server included in the electric mail received from the image processing apparatus 500. As a result, the image data receiving person is able to easily obtain the image data from the FTP server 110.

Further, in the second embodiment, after the operator operates the image processing apparatus 500 to read the original, the operator does not need to generate the electric mail including the FTP server name in which the image data is stored, the storage location (the folder name) and the file name of the FTP server, and the login ID and the password of the FTP server relative to the image data receiving person, thereby reducing an operational burden on the operator who operates the image processing apparatus 500 to read the original.

Further, the image data stored in the FTP server is administered in the state that only an account authenticated by the login ID and the password of the FTP server thus specified is allowed to access the image data. Accordingly, even when a plurality of unspecified persons is capable of accessing the FTP server where the image data is stored, it is possible to reduce a risk that the image data may be exposed to a third party.

The disclosure of Japanese Patent Application No. 2012-076617, filed on Mar. 29, 2012, is incorporated in the application.

While the invention has been explained with reference to the specific embodiments of the invention, the explanation is illustrative and the invention is limited only by the appended claims.

What is claimed is:

1. An image processing apparatus, comprising:
an image reading unit for reading image data of an original;
a communication unit for communicating through a communication network;
an image data transmission unit for transmitting the image data to a server specified with an input operation of an operator through the communication unit; and
an electric mail transmission unit for transmitting an electric mail to a destination specified with an input operation of the operator through the communication unit,
wherein said electric mail transmission unit is configured to transmit the electric mail including storage information of the image data in the server specified with the input operation of the operator and reading permission information of the image data to the destination specified with the input operation of the operator when the image data transmission unit transmits the image data to the server.

2. The image processing apparatus according to claim 1, further comprising:
an encryption unit for encrypting the image data read with the image reading unit; and
a decryption password generation unit for generating a password for decrypting the image data as the reading permission information,
wherein said electric mail transmission unit is configured to transmit the electric mail including the storage information of the image data in the server specified with the input operation of the operator and the password to the destination specified with the input operation of the operator when the image data transmission unit transmits the image data to the server.

3. The image processing apparatus according to claim 1, wherein said image data transmission unit is configured to transmit the image data to the server specified with the input operation of the operator through the communication unit,
wherein said server is configured to be accessible using a login ID and a login ID password as the reading permission information, and
said electric mail transmission unit is configured to transmit the electric mail including the storage information of the image data in the server specified with the input operation of the operator, the login ID and the login ID password to the destination specified with the input operation of the operator when the image data transmission unit transmits the image data to the server.

4. The image processing apparatus according to claim 1, wherein said image data transmission unit is configured to transmit the image data to the server through FTP (File Transfer Protocol).

5. The image processing apparatus according to claim 1, wherein said electric mail transmission unit is configured to transmit the electric mail including the storage information including a storage location and a file name of the image data in the server.
